(19) United States
(12) Patent Application Publication
(10) Pub. No.: US 2013/0044495 A1
(43) Pub. Date: Feb. 21, 2013

(54) LIGHTING FIXTURE EQUIPPED WITH A SHAPED REFLECTOR

(71) Applicants: Ping-Han CHUANG, New Taipei City (TW); Chia-Mei PENG, Ping-Chen City (TW)

(72) Inventors: Ping-Han CHUANG, New Taipei City (TW); Chia-Mei PENG, Ping-Chen City (TW)

(21) Appl. No.: 13/213,232

(22) Filed: Aug. 19, 2011

(51) Int. Cl. F21V 7/09

(52) U.S. Cl. 362/298

(57) ABSTRACT

A lighting fixture includes a light source, a lamp case, a power supply device, a shaped reflector and a prism. The shaped reflector has inwardly curved front and back walls each consisting of multiple conical faces abutted against one another and sloping at different angles. The angle of inclination of one lower conical face is relatively closer toward the center of the shaped reflector than that of the adjacent upper conical face. Thus, the shaped reflector effectively and evenly reflects the light emitted by the light source onto a predetermined rectangular or particularly shaped illumination area. Therefore, the lighting fixture is practical for road illumination, lounge illumination, advertizing light box and streamline table light applications to effectively and evenly illuminate the desired area, saving much power consumption.

### BACKGROUND OF THE INVENTION

1. Field of the Invention

The present invention relates to lighting fixture technology and more particularly, to a lighting fixture equipped with a shaped reflector. The shaped reflector has multiple reflective surfaces for reflecting light rays from the light source to a predetermined illumination area that can be a rectangular area or any other particularly confined area.

2. Description of the Related Art

A lighting fixture may be attached with a reflector to limit the illumination area and to enhance the light. Subject to the configuration of the reflector, the illumination area is relatively controlled.

FIG. 1A illustrates a conventional lighting fixture, which comprises a reflector having an arched reflective surface 101 on the middle and two sloping reflective surfaces 102;103 at two opposite lateral sides of the arched reflective surface 101. The reflector further comprises two through holes 104;105 respectively cut through the sloping reflective surfaces 102;103 for the mounting of a lamp tube 106. Thus, the illumination area of the light reflected by the reflector has a substantially rectangular shape.

FIG. 1B illustrates another structure of lighting fixture according to the prior art, which comprises a reflector that comprises a semi-elliptical reflective surface 107 and a through hole 108 cut through the semi-elliptical reflective surface 107 at one lateral side, and a lamp tube 109 inserted through the through hole 108 and suspending inside the reflector. Thus, the illumination area of the light reflected by the reflector has a substantially elliptical shape.

FIG. 1C illustrates still another structure of lighting fixture according to the prior art, which comprises a reflector that comprises a planar reflective surface 111 at the top side, an arched reflective surface 110 disposed around the planar reflective surface 111 and a through hole 112 cut through the planar reflective surface 111, and a lamp tube 113 vertically inserted through the through hole 112 and suspending in the reflector. Thus, the illumination area of the light reflected by the reflector has a substantially circular shape.

The aforesaid prior art designs can provide a rectangular, elliptical or circular illumination area, however, they are not practical for road illumination, lounge illumination, advertizing light box and streamline table light applications. When used for road illumination, lounge illumination, advertizing light box and streamline table light applications, it is necessary to increase the number of lighting fixtures so as to achieve the desired lighting power density. However, increasing the number of lighting fixtures relatively increases power consumption.

### SUMMARY OF THE INVENTION

The present invention has been accomplished under the circumstances in view. It is one object of the present invention to provide a lighting fixture, which is equipped with a shaped reflector that effectively and evenly reflects the light emitted by the light source onto a predetermined rectangular or particularly shaped illumination area, practical for road illumination, lounge illumination, advertizing light box and streamline table light applications

To achieve this and other objects of the present invention, a lighting fixture comprises a light source for producing light, and a shaped reflector surrounding the light source. The shaped reflector comprises a top wall, a bottom open side opposite to the top wall, two opposing sidewalls, a front wall and a back wall opposite to the front wall. The top wall, the sidewalls, the front wall and the back wall each have an inner surface adapted for reflecting the light emitted by the light source toward the bottom open side onto a predetermined illumination area. The sidewalls of the shaped reflector curve outwards, each comprising a plurality of conical faces abutted against one another at different elevations and sloping at different angles in such a manner that one upper conical face slopes relatively closer to the center of the shaped reflector than the adjacent lower conical face. The width of each sidewall reduces gradually in direction from the bottom open side of the shaped reflector toward the top wall thereof. The top wall of the shaped reflector curves inwards, comprising two symmetric sets of tapered faces that are abutted against one another and respectively sloping at a different angle toward the center of the shaped reflector, the angle of slope of one the tapered face that is relatively closer to the center of the shaped reflector being greater than the angle of slope of another the tapered face that is relatively farther from the center of the shaped reflector. The front wall and the back wall of the shaped reflector are respectively inwardly curved in reversed directions, having one same curvature and sloping downwardly outwardly in direction from the top wall of the shaped reflector toward the bottom open. The front wall and the back wall each have a width reducing gradually in direction from the bottom open side of the shaped reflector toward the top wall.

To achieve this and other objects of the present invention, a light source for producing light, and a shaped reflector surrounding the light source. The shaped reflector comprises a top wall, a bottom open side opposite to the top wall, two opposing sidewalls, a front wall and a back wall opposite to the front wall. The top wall, the sidewalls, the front wall and the back wall each have a reflective inner surface adapted for reflecting the light emitted by the light source toward the bottom open side onto a predetermined illumination area. Each sidewall of the shaped reflector comprises a first stepped arched wall portion, a second stepped arched wall portion and a first planar face horizontally connected between the first stepped arched wall portion and the second stepped arched wall portion. The first stepped arched wall portion and the second stepped arched wall portion each comprise a plurality of conical faces abutted against one another at different elevations and respectively and upwardly inwardly sloping at different angles in such a manner that one upper conical face slopes relatively closer to the center of the shaped reflector than the adjacent lower conical face, the width of the conical faces reducing gradually in direction from the bottom open side of the shaped reflector toward the top wall thereof. The front wall and the back wall of the shaped reflector are respectively inwardly curved in reversed directions, having one same curvature and sloping downwardly outwardly in direction from the top wall of the shaped reflector toward the bottom open. The front wall and the back wall each have a width reducing gradually in direction from the bottom open side of the shaped reflector toward the top wall. Further, the top wall of the shaped reflector is a planar wall.

Therefore, the lighting fixture is practical for road illumination, lounge illumination, advertizing light box and streamline table light applications to effectively and evenly illuminate the desired area, saving much power consumption

### BRIEF DESCRIPTION OF THE DRAWINGS

FIGS. 1A˜1C illustrate three different conventional reflectors.

FIG. 2A is a schematic plain view of a shaped reflector in accordance with a first embodiment of the present invention.

FIG. 2B is a bottom view of the shaped reflector in accordance with the first embodiment of the present invention.

FIG. 2C is an elevational view of the shaped reflector in accordance with the first embodiment of the present invention.

FIG. 2D is a bottom view of an alternate form of the shaped reflector in accordance with the first embodiment of the present invention.

FIG. 3A is a schematic plain view of a shaped reflector in accordance with a second embodiment of the present invention.

FIG. 3B is a bottom view of the shaped reflector in accordance with the second embodiment of the present invention.

FIG. 3C is an elevational view of the shaped reflector in accordance with the second embodiment of the present invention.

FIG. 3D is a bottom view of an alternate form of the shaped reflector in accordance with the second embodiment of the present invention.

FIG. 4A is a schematic plain view of a shaped reflector in accordance with a third embodiment of the present invention.

FIG. 4B is a bottom view of the shaped reflector in accordance with the third embodiment of the present invention.

FIG. 4C is an elevational view of the shaped reflector in accordance with the third embodiment of the present invention.

FIG. 5A is a schematic plain view of a shaped reflector in accordance with a fourth embodiment of the present invention.

FIG. 5B is a bottom view of the shaped reflector in accordance with the fourth embodiment of the present invention.

FIG. 6A is a schematic plain view of a shaped reflector in accordance with a fifth embodiment of the present invention.

FIG. 6B is a bottom view of the shaped reflector in accordance with the fifth embodiment of the present invention.

FIG. 7A is a schematic plain view of a shaped reflector in accordance with a sixth embodiment of the present invention.

FIG. 7B is a bottom view of the shaped reflector in accordance with the sixth embodiment of the present invention.

FIG. 8A is a schematic plain view of a shaped reflector in accordance with a seventh embodiment of the present invention.

FIG. 8B is a bottom view of the shaped reflector in accordance with the seventh embodiment of the present invention.

FIG. 9A is a schematic plain view of a shaped reflector in accordance with an eighth embodiment of the present invention.

FIG. 9B is a bottom view of the shaped reflector in accordance with the eighth embodiment of the present invention.

FIG. 10 is an oblique bottom elevational view of a shaped reflector in accordance with a ninth embodiment of the present invention.

FIG. 11A is a schematic drawing illustrating the paths of light reflected by the two opposing convex sidewalls of a shaped reflector constructed in accordance with the present invention.

FIG. 11B is a schematic drawing illustrating the effective illumination range of the two opposing convex sidewalls of a shaped reflector constructed in accordance with the present invention.

FIG. 12A is a schematic drawing illustrating the paths of light reflected by the opposing concave front and back walls of a shaped reflector constructed in accordance with the present invention.

FIG. 12B is a schematic drawing illustrating the effective illumination range of the opposing concave front and back walls of a shaped reflector constructed in accordance with the present invention.

FIG. 13 is a schematic sectional view of a ceiling lamp equipped with a shaped reflector constructed according to the present invention.

FIG. 14 is a schematic sectional view of a streetlight equipped with a shaped reflector constructed according to the present invention.

FIG. 15 is an elevational view of a shaped reflector in accordance with a tenth embodiment of the present invention.

FIG. 15A is a schematic plain view of the shaped reflector in accordance with the tenth embodiment of the present invention.

FIG. 16 is an elevational view of a shaped reflector in accordance with an eleventh embodiment of the present invention.

FIG. 16A is a schematic plain view of the shaped reflector in accordance with the eleventh embodiment of the present invention.

FIG. 17 is an elevational view of a shaped reflector in accordance with a twelfth embodiment of the present invention.

FIG. 17A is a schematic plain view of the shaped reflector in accordance with the twelfth embodiment of the present invention.

FIG. 18 is an elevational view of a shaped reflector in accordance with a thirteenth embodiment of the present invention.

FIG. 18A is a schematic plain view of the shaped reflector in accordance with the thirteenth embodiment of the present invention.

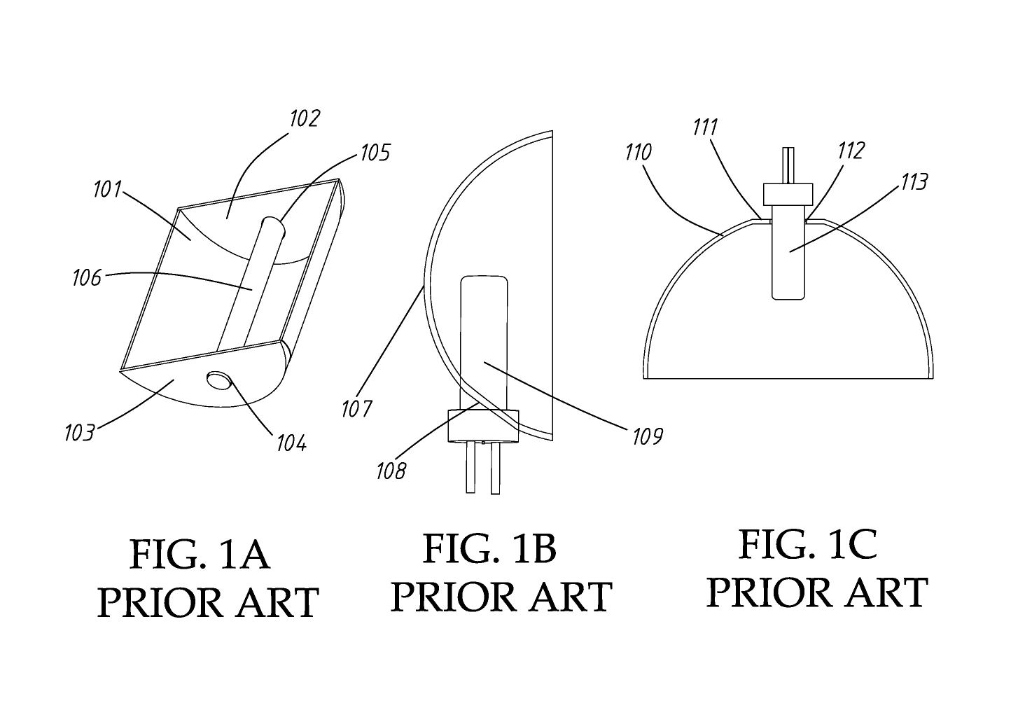

### DETAILED DESCRIPTION OF THE PREFERRED EMBODIMENT

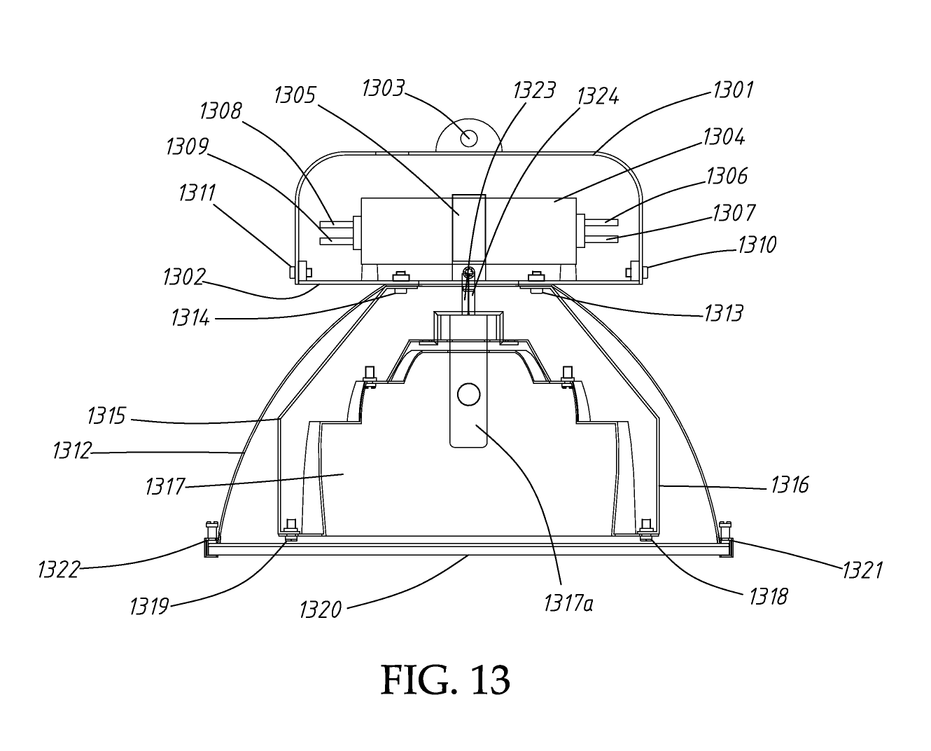

Referring to FIG. 13, a ceiling lamp equipped with a shaped reflector constructed according to the present invention is shown comprising:

an electric case body 1302;

an electric case cover 1301 covered on the electric case body 1302 and fastened thereto with screws 1310;1311, having a top eyelet 1303 for hanging;

a power supply device 1304 affixed to the electric case body 1302 with an iron plate 1305, having two power-output in electric wires 1306;1307 disposed at one side for connection to light source means and two power-input electric wires 1308;1309 for connection to an external power source;

a bottom-open dust cover 1312 surrounding the shaped reflector 1317 and affixed with two brackets 1316;1316 to the bottom wall of the electric case body 1302 by multiple nut and screw sets 1313;1314;

a shaped reflector 1317 affixed to the brackets 1316;1316 inside the bottom-open dust cover 1312 with two nut and screw sets 1318;1319 and holding a light source 1317a therein; and

a prism 1320 fastened to the bottom open side (light-emitting side) of the bottom-open dust cover 1312 with two screw-equipped clamps 1321;1322.

Based on the aforesaid component parts, a ceiling lamp having a shaped reflector is assembled. The main feature of the present invention is the design of the shaped reflector, which is described and explained hereinafter.

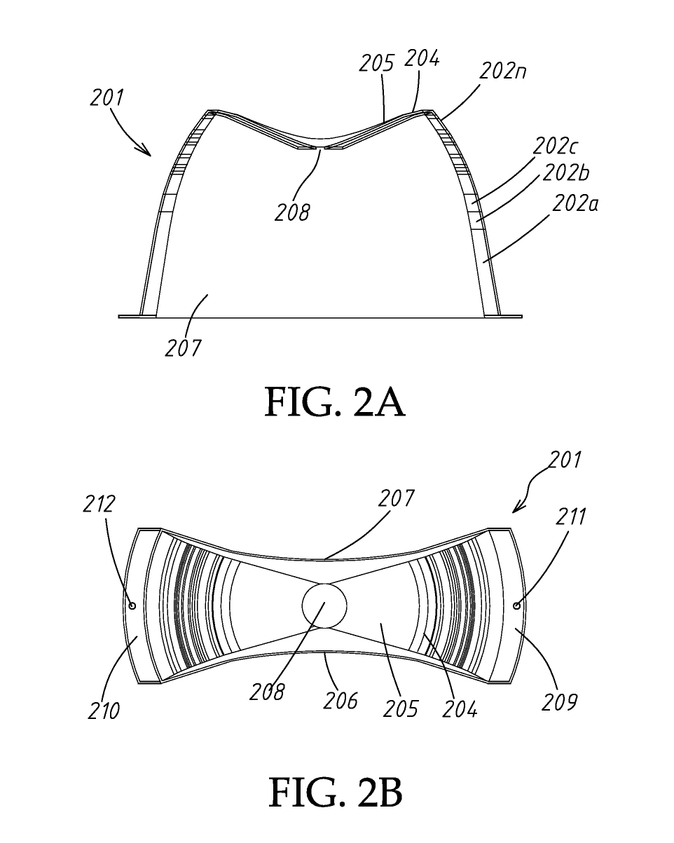

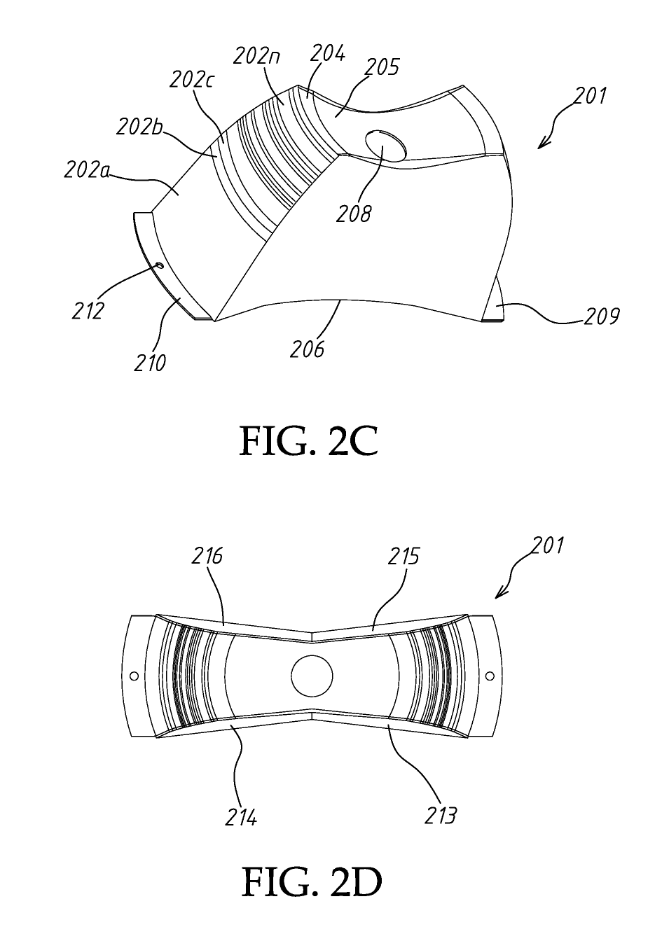

Referring to FIGS. 2A˜2C, a shaped reflector 201 in accordance with a first embodiment of the present invention is shown. The inner surface of the shaped reflector 201 is a light reflective surface. The shaped reflector 201 has two opposing sidewalls, opposing front and back walls, a top wall and a bottom open side. The sidewalls, front and back walls and top wall of the shaped reflector 201 have the respective inner surfaces thereof adapted for reflecting light toward a predetermined illumination zone. Each sidewall of the shaped reflector 201 curves outwards and consists of a plurality of tapered faces 202a˜202n abutted against one another at different elevations and respectively sloping at a different angle. The tapered faces 202a˜202n slope in such a manner that the sloping angle of one upper tapered face is relatively greater than the adjacent lower tapered face. Further, the shaped reflector 201 has two opposing sidewalls have a width reducing gradually in direction from the bottom open side of the shaped reflector 201 toward the top wall thereof, as shown in FIG. 2B. According to this first embodiment, the two opposing sidewalls of the shaped reflector 201 are symmetric.

The top wall of the shaped reflector 201 curves inwards, consisting of two symmetric sets of tapered faces 204;205 that are abutted against each other (or one another) and respectively sloping at a different angle toward the center of the shaped reflector 201.

Referring to FIG. 2B, the front and back walls of the shaped reflectors 201 are concave faces 206;207 that are symmetric and respectively inwardly curved in reversed directions, having the same curvature. Further, the two concave faces 206;207 slope downwardly outwardly from the top wall of the shaped reflector 201 toward the bottom open side thereof. Further, the two concave faces 206;207 have a width reducing gradually in direction from the bottom wall of the shaped reflector 201 toward the top wall thereof.

The shaped reflector 201 further comprises a through hole 208 disposed at the center of the top wall thereof for receiving the lamp tube of a light source, two planar bottom flanges 209;210 respectively outwardly extended from the bottom side of each of the two opposing sidewalls thereof in a flush manner relative to the bottom open side, and a mounting through hole 211;212 respectively located on each of the two planar bottom flanges 209;210 for fastening to the lighting fixture in which the shaped reflector 201 is used.

Referring to FIG. 2D, each of the front and back walls of the shaped reflector 201 can be formed of at least two connected planar faces 213;214 and 215;216 (or concave faces or convex faces) that slope downwardly outwardly from the top wall of the shaped reflector 201 toward the bottom open side thereof in a direction away from the center of the shaped reflector 201. Further, the front and back walls of the shaped reflector 201 have a width reducing gradually in direction from the bottom open side of the shaped reflector 201 toward the top wall thereof.

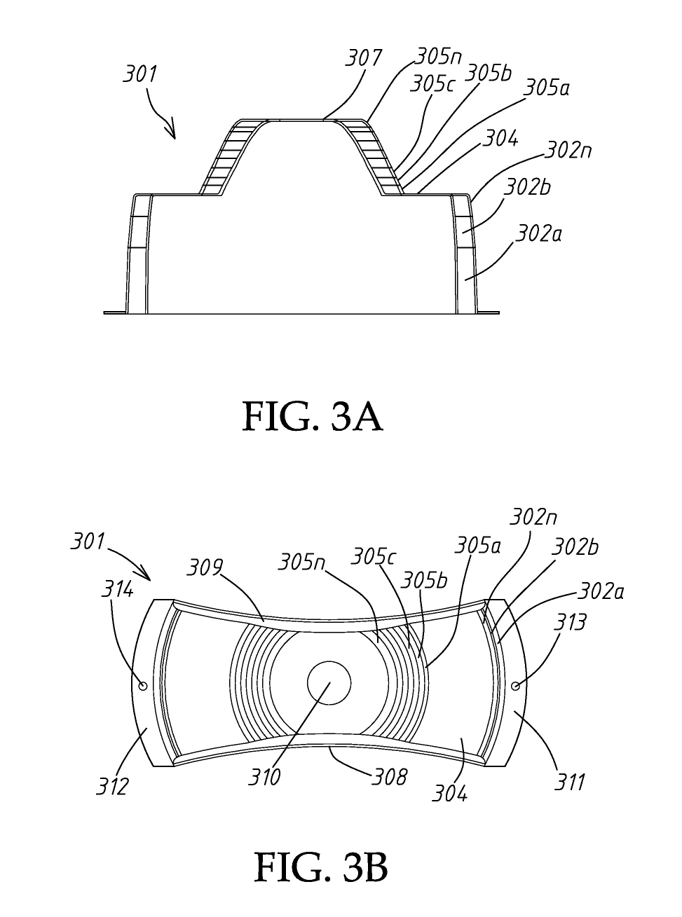

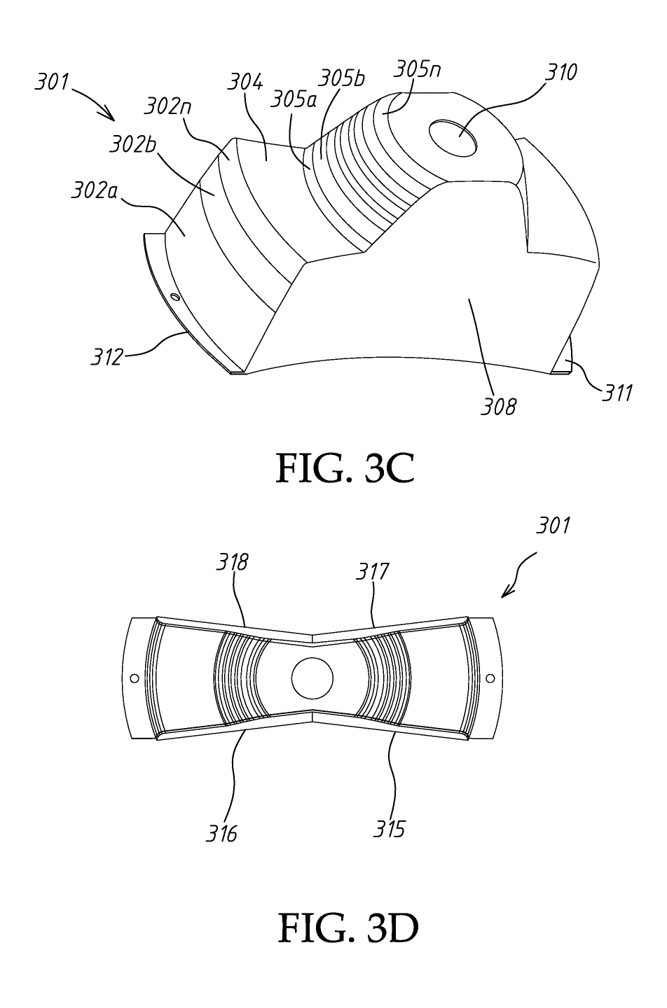

FIGS. 3A˜3C illustrate a shaped reflector 301 in accordance with a second embodiment of the present invention. According to this second embodiment, each of the two opposing sidewalls comprises a first stepped arched wall portion and a second stepped arched wall portion. The first stepped arched wall portion consists of a plurality of conical faces 302a˜302n that are abutted against one another at different elevations and respectively and upwardly inwardly sloping at different angles in such a manner that one upper conical face slopes relatively closer to the center of the shaped reflector 301 than the adjacent lower conical face. Further, the width of the first stepped arched wall portion reduces gradually from the bottom open side of the shaped reflector 301 toward the top wall thereof.

Further, a sector planar face 304 is horizontally connected between the first stepped arched wall portion and second stepped arched wall portion of each sidewall of the shaped reflector 301.

The second stepped arched wall portion consists of a plurality of conical faces 305a˜305n that are abutted against one another at different elevations and respectively and upwardly inwardly sloping at different angles in such a manner that one upper conical face slopes relatively closer to the center of the shaped reflector 301 than the adjacent lower conical face. Further, the width of the second stepped arched wall portion reduces gradually in direction toward the top wall of the shaped reflector 301, as shown in FIG. 3B. According to this second embodiment, the two opposing sidewalls of the shaped reflector 301 are symmetric.

The top wall of the shaped reflector 301 is a planar face 307 horizontally connected between the top edge of the second stepped arched wall portion of each of the two opposing sidewalls of the shaped reflector 301.

Referring to FIG. 3B, the opposing front and back walls of the shaped reflector 301 are concave faces 308;309 that curve in reversed direction, slope at one same angle and have the same curvature. These two concave faces 308;309 slope downwardly outwards. The width of these two concave faces 308;309 reduces gradually in direction toward the top wall of the shaped reflector. Further, these two concave faces 308;309 are symmetric.

The shaped reflector 301 further comprises a through hole 310 disposed at the center of the top wall thereof for receiving the lamp tube of a light source, two planar bottom flanges 311;312 respectively outwardly extended from the bottom side of each of the two opposing sidewalls thereof in a flush manner relative to the bottom open side, and a mounting through hole 313;313 respectively located on each of the two planar bottom flanges 311;312 for fastening to the lighting fixture in which the shaped reflector 301 is used.

Referring to FIG. 3D, each of the two concave faces 308;309 of the shaped reflector 301 can be formed of at least two connected planar faces 315;316 and 317;318 (or concave faces, or arched faces, or convex faces) that slope downwardly outwardly from the top wall of the shaped reflector 301 in a direction away from the center of the shaped reflector 301. Further, the front and back walls of the shaped reflector 301 have a width reducing gradually in direction from the bottom open side of the shaped reflector 301 toward the top wall thereof.

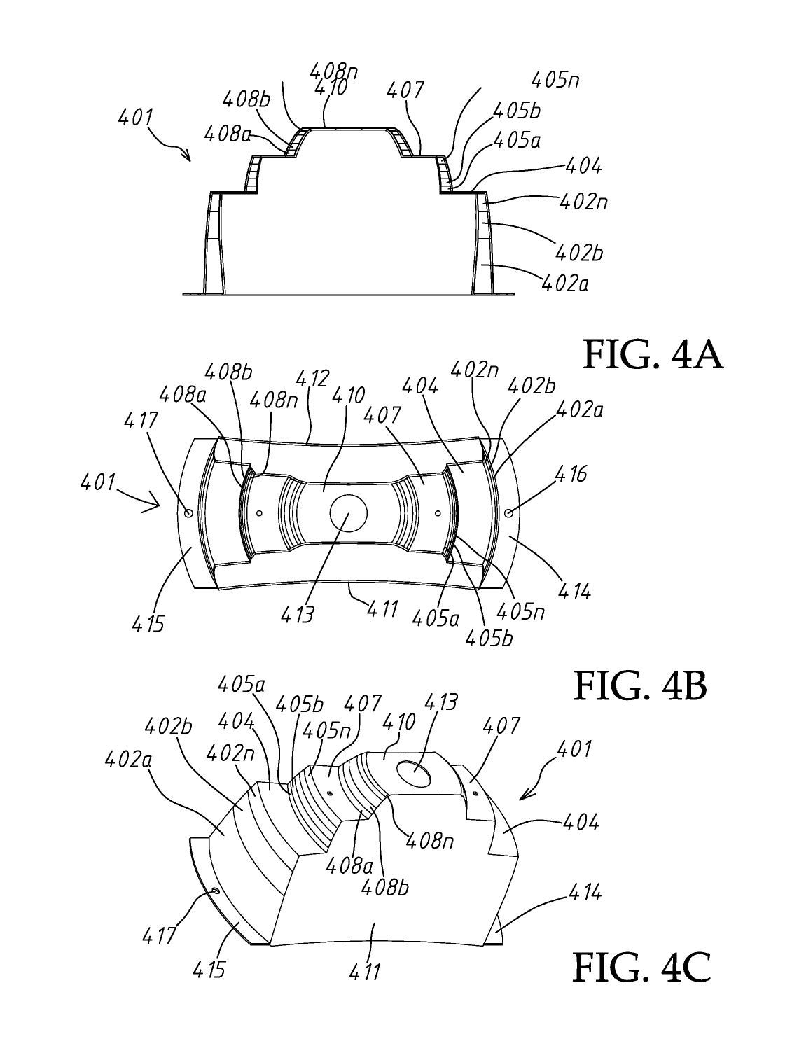

FIGS. 4A˜4C illustrate a shaped reflector 401 in accordance with a third embodiment of the present invention. According to this third embodiment, each of the two opposing sidewalls comprises a first stepped arched wall portion, a second stepped arched wall portion and a third stepped arched wall portion. The first stepped arched wall portion consists of a plurality of conical faces 402a˜402n that are abutted against one another at different elevations and respectively and upwardly inwardly sloping at different angles in such a manner that one upper conical face slopes relatively closer to the center of the shaped reflector 401 that the adjacent lower conical face. Further, the width of the first stepped arched wall portion reduces gradually in direction from the bottom open side of the shaped reflector 401 toward the top wall thereof.

Further, a first sector planar face 404 is horizontally connected between the first stepped arched wall portion and second stepped arched wall portion of each sidewall of the shaped reflector 401.

The second stepped arched wall portion consists of a plurality of conical faces 405a˜405n that are abutted against one another at different elevations and respectively and upwardly inwardly sloping at different angles in such a manner that one upper conical face slopes relatively closer to the center of the shaped reflector 401 than the adjacent lower conical face. Further, the width of the second stepped arched wall portion reduces gradually in direction toward the top wall of the shaped reflector 401, as shown in FIG. 4B. According to this third embodiment, the two opposing sidewalls of the shaped reflector 401 are symmetric.

Further, a second sector planar face 407 is horizontally connected between the second stepped arched wall portion and third stepped arched wall portion of each sidewall of the shaped reflector 401.

The third stepped arched wall portion consists of a plurality of conical faces 408a˜408n that are abutted against one another at different elevations and respectively and upwardly inwardly sloping at different angles in such a manner that one upper conical face slopes relatively closer to the center of the shaped reflector 401 than the adjacent lower conical face. Further, the width of the third stepped arched wall portion reduces gradually in direction toward the top wall of the shaped reflector 401, as shown in FIG. 4B.

The top wall of the shaped reflector 401 is a planar face 410 horizontally connected between the top edge of the third stepped arched wall portion of each of the two opposing sidewalls of the shaped reflector 401.

Referring to FIG. 4B, the opposing front and back walls of the shaped reflector 401 are concave faces 411;412 that curve in reversed direction, slope at one same angle and have the same curvature. These two concave faces 411;412 slope downwardly outwards. The width of these two concave faces 411;412 reduces gradually in direction toward the top wall of the shaped reflector. Further, these two concave faces 411;412 are symmetric.

The shaped reflector 401 further comprises a through hole 413 disposed at the center of the top wall thereof for receiving the lamp tube of a light source, two planar bottom flanges 414;415 respectively outwardly extended from the bottom side of each of the two opposing sidewalls thereof in a flush manner relative to the bottom open side, and a mounting through hole 417;418 respectively located on each of the two planar bottom flanges 414;415 for fastening to the lighting fixture in which the shaped reflector 401 is used.

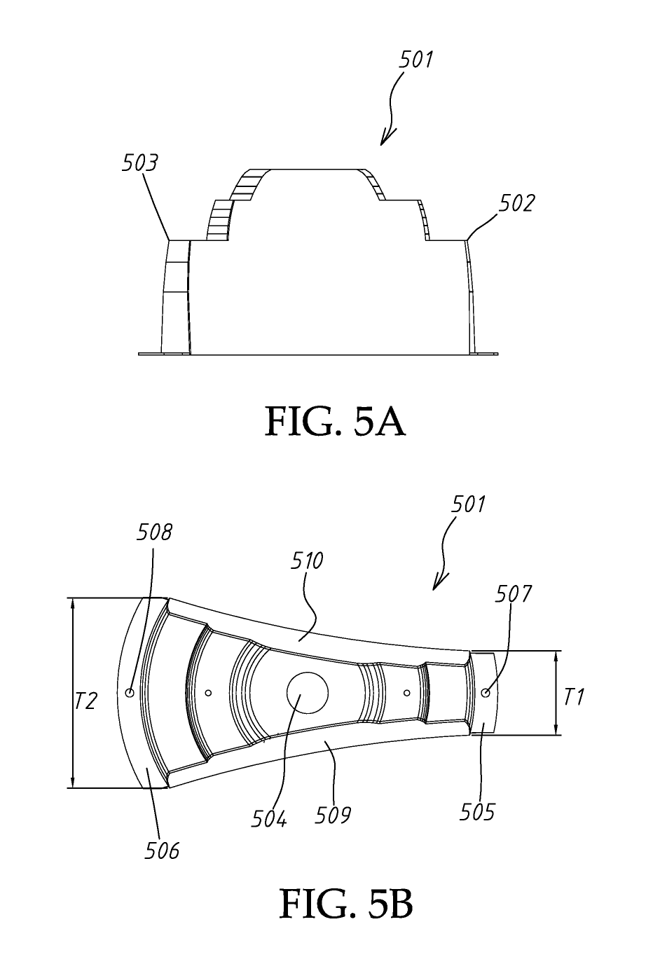

FIGS. 5A˜5C illustrate a shaped reflector 501 in accordance with a fourth embodiment of the present invention. This fourth embodiment is substantially similar to the aforesaid third embodiment shown in FIGS. 4A and 4B, having three stepped arched wall portions at each of the two opposing sidewalls thereof. However, in this fourth embodiment, the width T1 of one sidewall (the right sidewall) 502 of the shaped reflector 501 is relatively smaller than the width T2 of the other sidewall (the left sidewall) 503 of the shaped reflector 501, i.e., the widths of the two opposing sidewalls 502;503 are asymmetric, however both sidewalls 502;503 reduce in width gradually in direction from the bottom open side of the shaped reflector 501 toward the top wall thereof.

The opposing front and back walls of the shaped reflector 501 are concave faces 509;510 that curve in reversed direction, slope at one same angle and have the same curvature. These two concave faces 509;510 slope downwardly outwards. The width of these two concave faces 509;510 reduces gradually in direction toward the top wall of the shaped reflector 501. Further, these two concave faces 509;510 are symmetric.

The shaped reflector 501 further comprises a through hole 504 disposed at the center of the top wall thereof for receiving the lamp tube of a light source, two planar bottom flanges 505;506 respectively outwardly extended from the bottom side of each of the two opposing sidewalls thereof in a flush manner relative to the bottom open side, and a mounting through hole 507;508 respectively located on each of the two planar bottom flanges 505;506 for fastening to the lighting fixture in which the shaped reflector 501 is used.

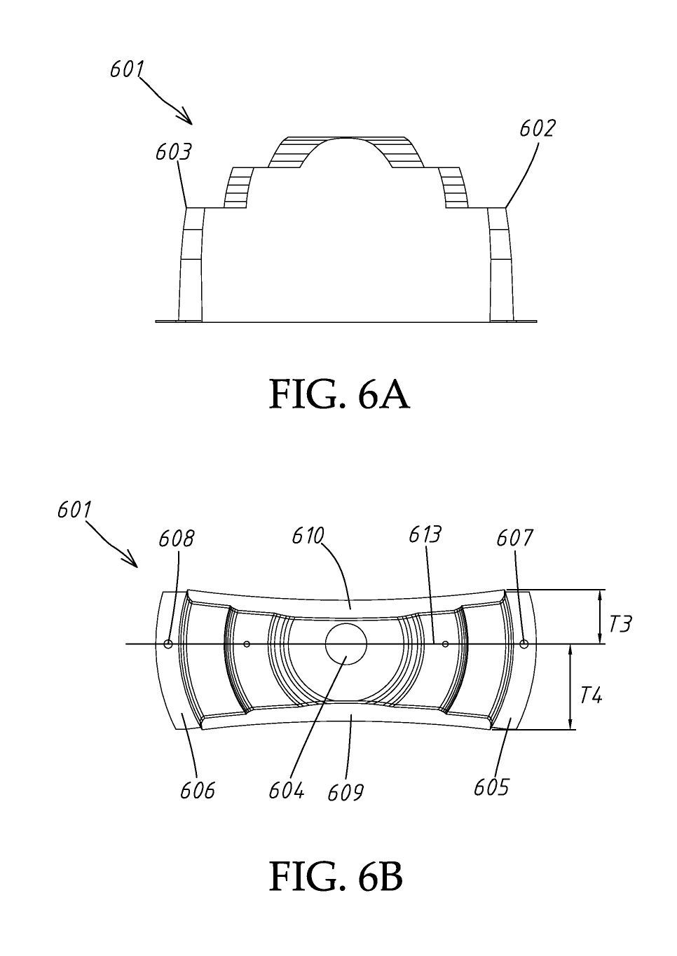

FIGS. 6A˜6C illustrate a shaped reflector 601 in accordance with a fifth embodiment of the present invention. This fifth embodiment is substantially similar to the aforesaid third embodiment shown in FIGS. 4A and 4B, having three stepped arched wall portions at each of the two opposing sidewalls 602;603 thereof. However, in this fifth embodiment, as shown in FIG. 6B, the stepped sidewalls 602;603 are symmetric, each having a relatively shorter first-width part T3 and a relatively greater second-width part T4. Further, the sidewalls 602;603 reduce in width gradually in direction from the bottom open side of the shaped reflector 601 toward the top wall thereof. The opposing front and back walls of the shaped reflector 601 are concave faces 609;610 that curve in reversed direction, slope at one same angle and have one same radius. These two concave faces 609;610 slope downwardly outwards. The width of these two concave faces 609;610 reduces gradually in direction toward the top wall of the shaped reflector 601. Further, these two concave faces 609;610 are asymmetric. The shaped reflector 601 further comprises a through hole 604 disposed at the center of the top wall thereof for receiving the lamp tube of a light source, two planar bottom flanges 605;606 respectively outwardly extended from the bottom side of each of the two opposing sidewalls thereof in a flush manner relative to the bottom open side, and a mounting through hole 607;608 respectively located on each of the two planar bottom flanges 605;606 for fastening to the lighting fixture in which the shaped reflector 601 is used.

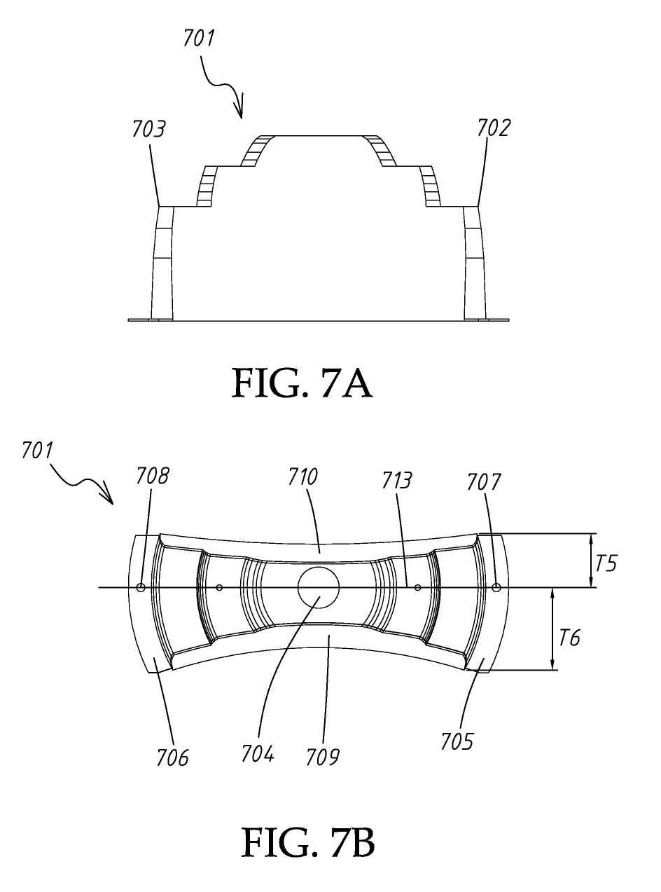

FIGS. 7A and 7B illustrate a shaped reflector 701 in accordance with a sixth embodiment of the present invention. This sixth embodiment is substantially similar to the aforesaid third embodiment shown in FIGS. 4A and 4B, having three stepped arched wall portions at each of the two opposing sidewalls 702;703 thereof. However, in this sixth embodiment, as shown in FIG. 7B, the stepped sidewalls 702;703 are symmetric, each having a relatively shorter first-width part T5 and a relatively greater second-width part T6. Further, the sidewalls 702;703 reduce in width gradually in direction from the bottom open side of the shaped reflector 701 toward the top wall thereof. The opposing front and back walls of the shaped reflector 701 are concave faces 709;710 that are not concentric, have a different radius and slope at a different angle. These two concave faces 709;710 slope downwardly outwards. The width of these two concave faces 709;710 reduces gradually in direction toward the top wall of the shaped reflector 701. Further, these two concave faces 709;710 are asymmetric. The shaped reflector 701 further comprises a through hole 704 disposed at the center of the top wall thereof for receiving the lamp tube of a light source, two planar bottom flanges 705;706 respectively outwardly extended from the bottom side of each of the two opposing sidewalls thereof in a flush manner relative to the bottom open side, and a mounting through hole 707;708 respectively located on each of the two planar bottom flanges 705;706 for fastening to the lighting fixture in which the shaped reflector 701 is used.

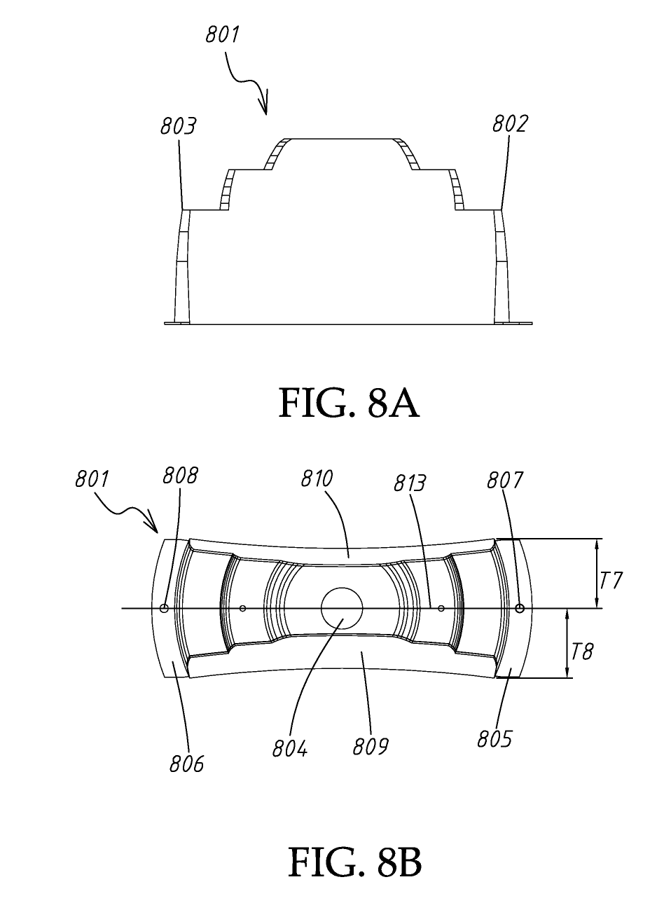

FIGS. 8A and 8B illustrate a shaped reflector 801 in accordance with a seventh embodiment of the present invention. This seventh embodiment is substantially similar to the aforesaid third embodiment shown in FIGS. 4A and 4B, having three stepped arched wall portions at each of the two opposing sidewalls 802;803 thereof. However, in this seventh embodiment, as shown in FIG. 7B, the stepped sidewalls 802;803 are symmetric, each having equal first-width part T7 and second-width part T8. Further, the sidewalls 802;803 reduce in width gradually in direction from the bottom open side of the shaped reflector 801 toward the top wall thereof. The opposing front and back walls of the shaped reflector 801 are concave faces 809;810 that are not concentric, have one same radius and slope at a different angle. These two concave faces 809;810 slope downwardly outwards. The width of these two concave faces 809;810 reduces gradually in direction toward the top wall of the shaped reflector 801. Further, these two concave faces 809;810 are asymmetric. The shaped reflector 801 further comprises a through hole 804 disposed at the center of the top wall thereof for receiving the lamp tube of a light source, two planar bottom flanges 805;806 respectively outwardly extended from the bottom side of each of the two opposing sidewalls thereof in a flush manner relative to the bottom open side, and a mounting through hole 807;808 respectively located on each of the two planar bottom flanges 805;806 for fastening to the lighting fixture in which the shaped reflector 801 is used.

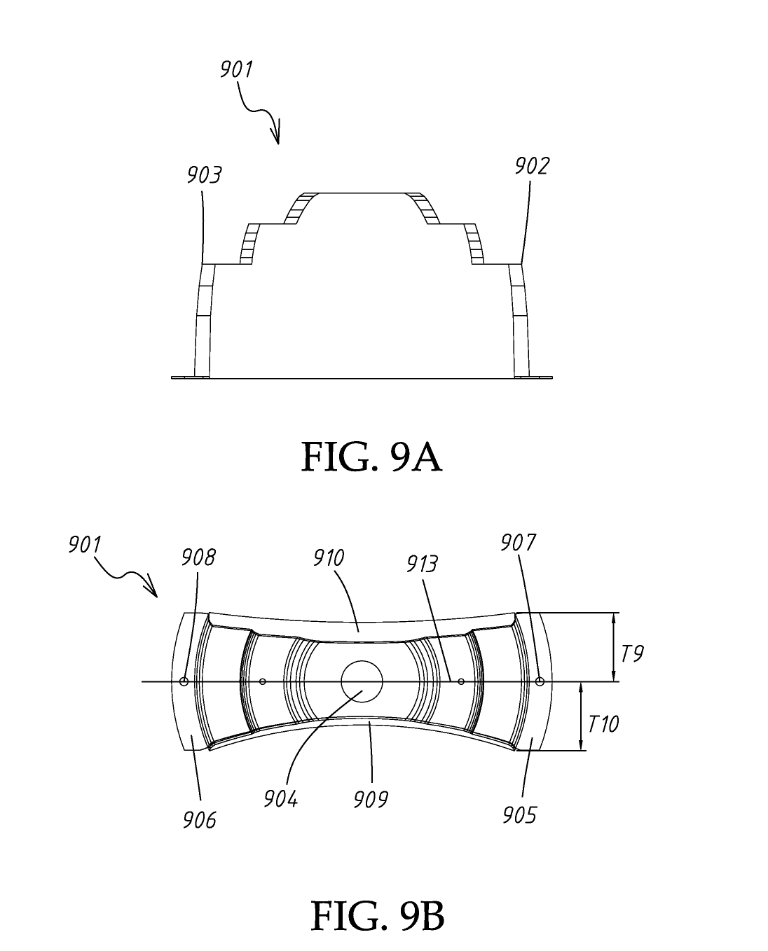

FIGS. 9A and 8B illustrate a shaped reflector 901 in accordance with an eighth embodiment of the present invention.

This eighth embodiment is substantially similar to the aforesaid third embodiment shown in FIGS. 4A and 4B, having three stepped arched wall portions at each of the two opposing sidewalls 902;903 thereof. However, in this eighth embodiment, as shown in FIG. 8B, the stepped sidewalls 902;903 are symmetric, each having equal first-width part T9 and second-width part T10. Further, the sidewalls 902;903 reduce in width gradually in direction from the bottom open side of the shaped reflector 901 toward the top wall thereof. The opposing front and back walls of the shaped reflector 901 are concave faces 909;910 that are not concentric, have a different radius and slope at a different angle. These two concave faces 909;910 slope downwardly outwards. The width of these two concave faces 909;910 reduces gradually in direction toward the top wall of the shaped reflector 901. Further, these two concave faces 909;910 are asymmetric. The shaped reflector 901 further comprises a through hole 904 disposed at the center of the top wall thereof for receiving the lamp tube of a light source, two planar bottom flanges 905;906 respectively outwardly extended from the bottom side of each of the two opposing sidewalls thereof in a flush manner relative to the bottom open side, and a mounting through hole 907;908 respectively located on each of the two planar bottom flanges 905;906 for fastening to the lighting fixture in which the shaped reflector 901 is used.

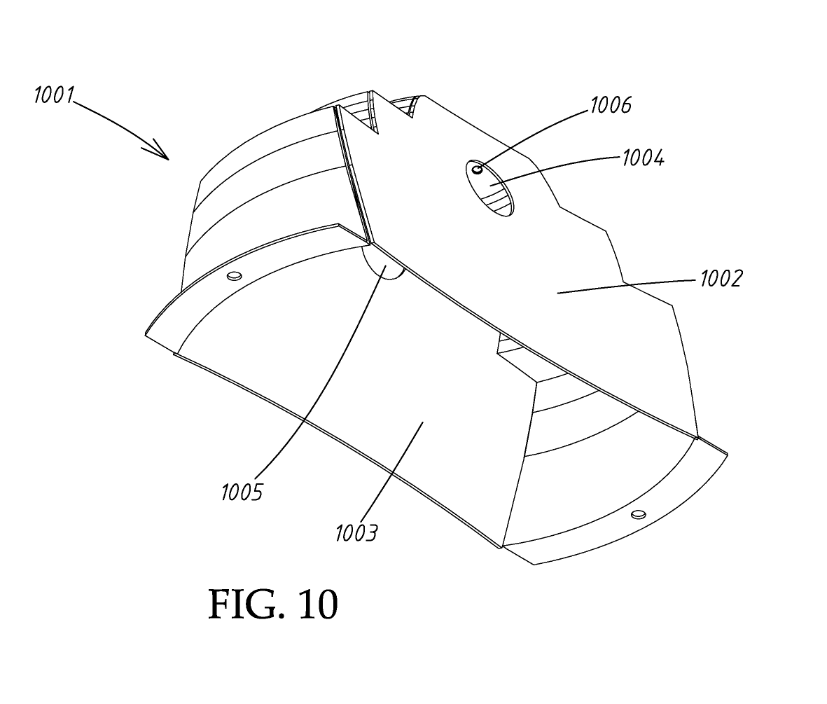

FIG. 10 illustrates a shaped reflector 1001 in accordance with a ninth embodiment of the present invention. This ninth embodiment is substantially similar to the aforesaid third embodiment shown in FIGS. 4A and 4B with the exception that the shaped reflector 1001 has a through hole 1004;1005 located on each of the opposing concave front and back walls 1002;1003 thereof for receiving a lamp tube, and a through hole 1006 located on the top wall thereof for the mounting of a lamp holder.

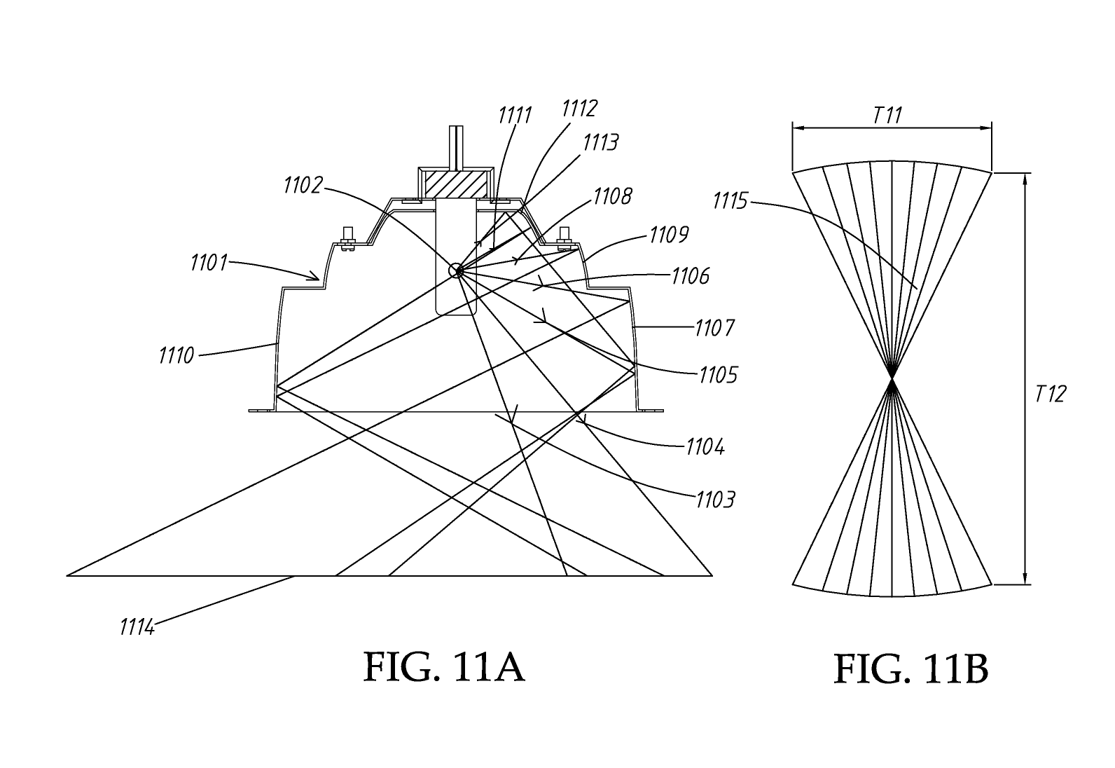

FIG. 11A illustrates the paths of light reflected by the two opposing convex sidewalls of a shaped reflector constructed in accordance with a third embodiment of the present invention shown in FIGS. 4A and 4B. As illustrated, a lamp tube 1102 is mounted inside the shaped reflector 1101. During operation of the lamp tube 1102, light rays 1103;1104 of the light emitted by the lamp tube 1102 directly go through the light-emitting open side of the shaped reflector 1101 to the illumination area 114; light rays 1108 of the light emitted by the lamp tube 1102 are primarily reflected by the second stepped arched wall portion 1109 of one sidewall of the shaped reflector 1101 toward the first stepped arced wall portion 1110 of the other sidewall of the shaped reflector 1101 and then secondarily reflected by the first stepped arched wall portion 1110 onto the illumination area 114; light rays 1111 of the light emitted by the lamp tube 1102 are primarily reflected by the third stepped arched wall portion 1112 of one sidewall of the shaped reflector 1101 toward the first stepped arched wall portion 1110 of the other sidewall of the shaped reflector 1101 and then secondarily reflected by the first stepped arched wall portion 1110 onto the illumination area 114; light rays 1113 of the light emitted by the lamp tube 1102 are primarily reflected by the planar plane at the top side of the third stepped arched wall portion 1112 of one sidewall of the shaped reflector 1101 toward the first stepped arched wall portion 1101 of the same sidewall of the shaped reflector 1101 and then secondarily reflected by the respective first stepped arched wall portion 1107 onto the illumination area 114.

FIG. 11B is a schematic drawing illustrating the effective illumination range of the two opposing convex sidewalls of a shaped reflector constructed in accordance with the present invention. As illustrated, the illumination area 115 of the light emitted by the light source and reflected by the two opposing sidewalls of the shaped reflector 1101 shows the configuration of two symmetric sectors and crossed light rays. The illumination width T11 is determined subject to the width of the reflective surfaces of the two opposing convex sidewalls of the shaped reflector 1101. Both the illumination width T11 and the width of the reflective surfaces of the two opposing convex sidewalls of the shaped reflector 1101 are directly proportional. The illumination width T11 is also determined subject to the radius of the reflective surfaces of the two opposing convex sidewalls of the shaped reflector 1101. The smaller the radius is, the greater the illumination width will be. The illumination length T12 is determined subject to the angle of slope of the two opposing convex sidewalls of the shaped reflector 1101.

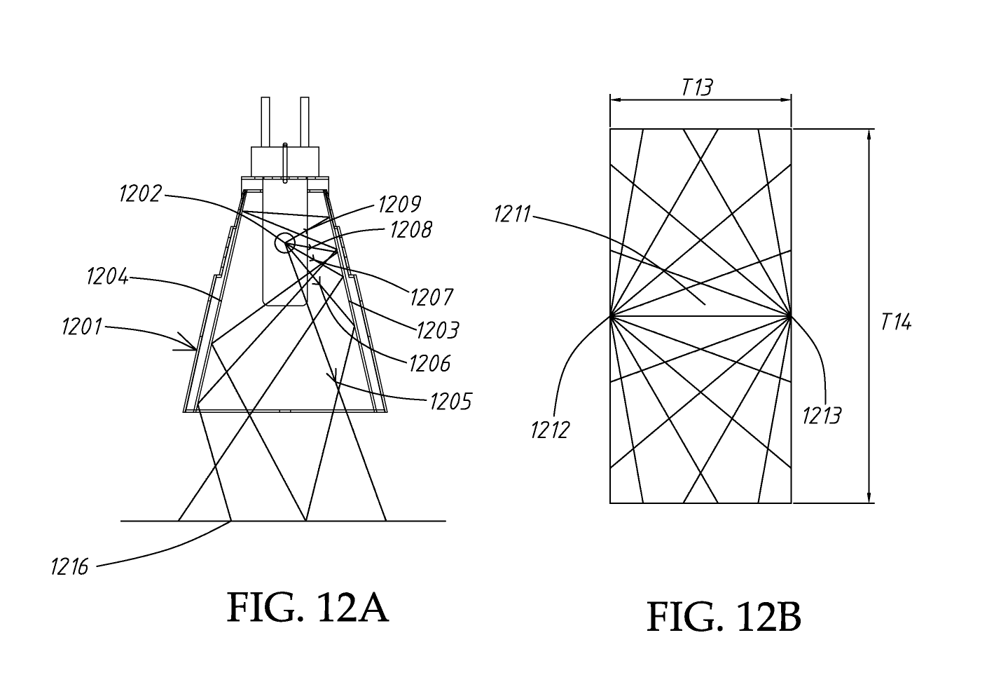

FIG. 12A is a schematic drawing illustrating the paths of light reflected by the opposing concave front and back walls of a shaped reflector constructed in accordance with the present invention. The shaped reflector 1201 is similar to that shown in FIG. 11A, having a lamp tube 1202 mounted therein. During operation of the lamp tube 1202, light rays 1205 of the light emitted by the lamp tube 1202 directly go through the light-emitting open side of the shaped reflector 1201 to the illumination area 1216; light rays 1306;1207 of the light emitted by the lamp tube 1202 are reflected by the concave front wall 1203 of the shaped reflector 12101 onto the illumination area 114; light rays 1208 of the light emitted by the lamp tube 1202 are primarily reflected by the concave front wall 1203 of the shaped reflector 12101 toward the concave back wall 1204 and then secondarily reflected by the concave back wall 1204 onto the illumination area 1216; light rays 1209 of the light emitted by the lamp tube 1202 are alternatively reflected by the concave front wall 1203 and the concave back wall 1204 twice and then go to the illumination area 1216.

FIG. 12B is a schematic drawing illustrating the effective illumination range of the opposing concave front and back walls of a shaped reflector constructed in accordance with the present invention. As illustrated, the illumination area 1211 of the light emitted by the light source and reflected by the opposing concave front and back walls of the shaped reflector 1201 shows the configuration of two symmetric sectors and crossed light rays, wherein the light rays 1212 or 1213 in each sector disperse from the center toward the two opposite sides without intersection or overlap. Because the reflective inner surface of each of the front and back walls is a concave surface, reflected light rays are dispersed toward two opposite lateral sides. Similarly, if the concave front and back walls are respectively formed of two planar faces, reflected light rays will also be dispersed toward two opposite lateral sides. The illumination width T13 is determined subject to the width of the angle of slope of the opposing concave front and back walls of the shaped reflector 1201. The greater the angle of slope is, the wider the illumination width will be. On the contrary, the smaller the angle of slope is, the narrower the illumination width will be. The illumination length T14 is determined subject to the radius of the two opposing concave front and back walls of the shaped reflector 1201. The greater the radius is, the shorter the illumination length will be. On the contrary, the shorter the radius is, the longer the illumination length will be.

Further, overlapping the illumination area shown in FIG. 11B and the illumination area shown in FIG. 12B form a rectangular illumination area 1211 in which light rays are evenly distributed.

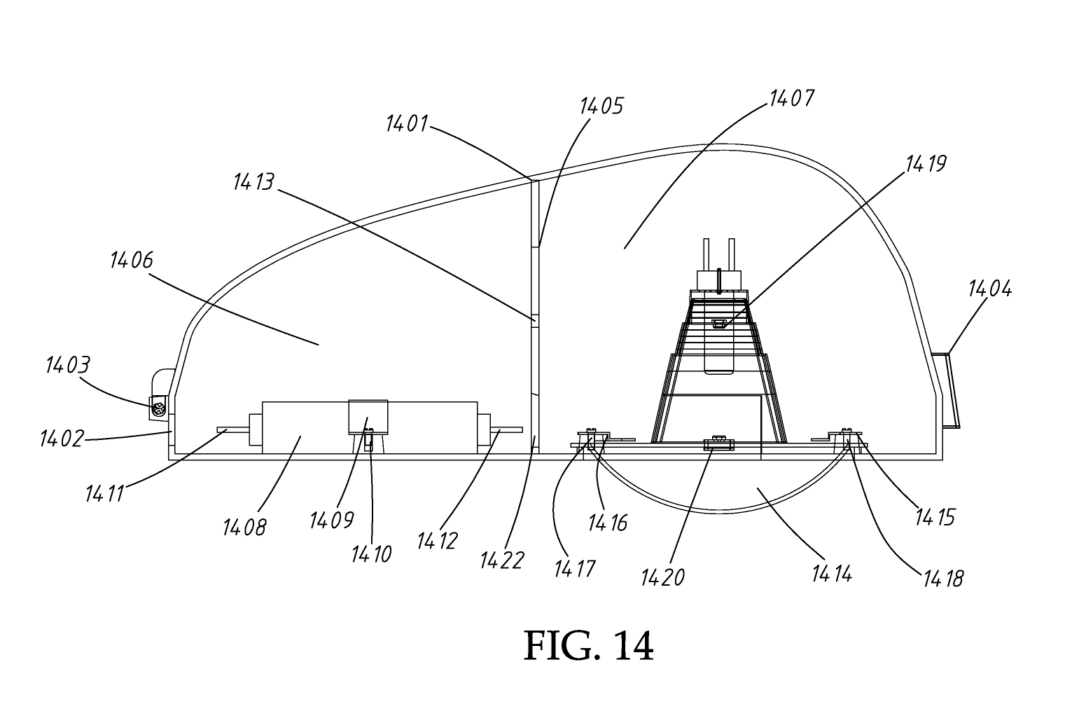

FIG. 14 is a schematic sectional view of a streetlight equipped with a shaped reflector constructed according to the present invention. As illustrated, the streetlight comprises a lamp case body 1402, a lamp case cover 1401 pivotally connected to the lamp case body 1402 with screw bolt 1403, a lock 1404 for locking the lamp case cover 1401 to the lamp case body 1402 in the close position, a first partition wall 1422 vertically upwardly extended from the lamp case body 1402, a second partition wall 1405 vertically downwardly extended from the lamp case cover 1401 and abutted against the first partition wall 1422 to divide the holding space in between the lamp case body 1402 and the lamp case cover 1401 into a first chamber 1406 and a second chamber 1407, a power supply device 1408 mounted in the first chamber 1406 and affixed to the lamp case body 1402 with an iron plate 1409 and screws 1410, two power-output electric wires 1412 inserted through a hole 1413 in the first partition wall 1422 and electrically connecting the power supply device 1408 to the lamp tube, two power-input electric wires 1411 electrically connecting the power supply device 1408 to an external power source, a prism 1414 fastened to an opening (light-emitting side) at the lamp case body 1402 corresponding to the second chamber 1407 with iron plates 1415;1416 and screws 1417;1418, and a shaped reflector 1417 affixed to the prism 1414 with a screw-equipped clamp 1420 and holding a light source therein.

A lighting fixture equipped with a shaped reflector in accordance with the present invention is practical for road illumination, lounge illumination, advertizing light box and streamline table light applications to effectively and evenly illuminate the desired area, saving much power consumption.

The structures shown in FIGS. 5-9 are similar to that shown in FIG. 4A for easy understanding of the structural features of the invention. These modifications achieve the same effect as that shown in FIGS. 2 and 3. It is to be understood that the number of the arched or conical faces of the sidewalls of the shaped reflector illustrated in the drawings are simply for understanding of the structural features of the present invention but not intended as a limitation. In actual practice, each sidewall of the shaped reflector can be substantially arched and formed of a big number of arched or conical faces that abutted one against another.

The lighting fixtures shown in FIGS. 13 and 14 are simply application examples of the invention in which one light source and one shaped reflector are used. In actual practice, the lighting fixture can be a LED lamp, comprising multiple shaped reflectors and a LED light source in each shaped reflector.

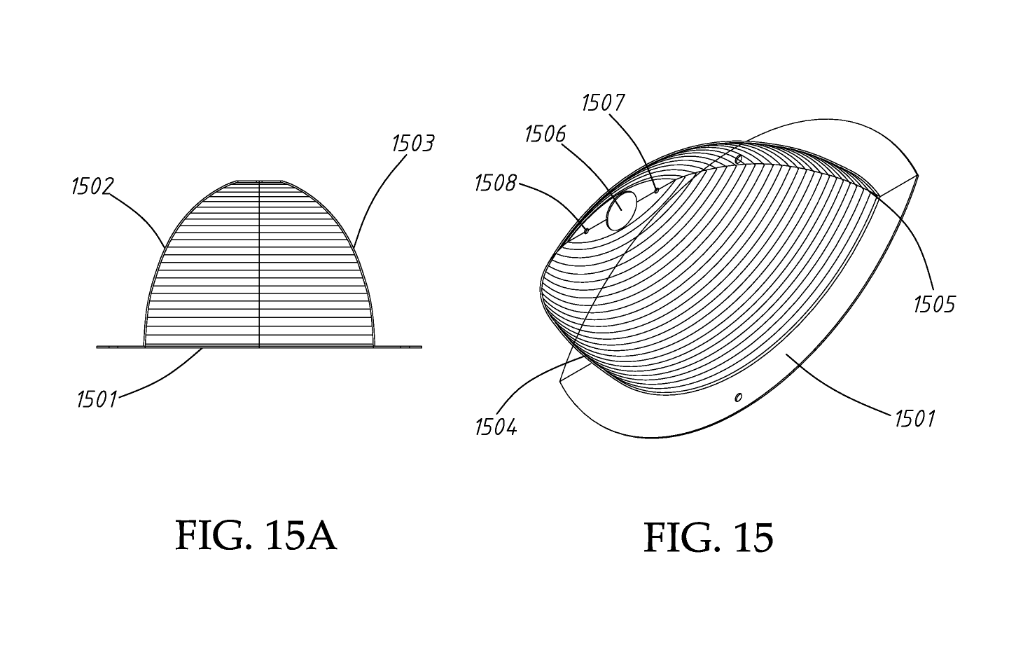

FIGS. 15 and 15A illustrate a shaped reflector 1501 in accordance with a tenth embodiment of the present invention. According to this tenth embodiment, the inner surface of the shaped reflector 1501 is a light reflective surface; the two opposing lateral sidewalls 1502;1503 are convex walls each consisting of a plurality of conical faces abutted against one another at different elevations and sloping at different angles in such a manner that each conical face slopes upwardly toward the center of the reflector 1501 and one upper conical face slopes relatively closer to the center of the shaped reflector than the adjacent lower conical face and each conical face has a width gradually reducing in direction from the bottom side of the reflector 1501 toward the top side thereof; the opposing front wall 1504 and back wall 1505 of the reflector 1501 are convex walls connected between the two opposing lateral sidewalls 1502;1503 in an enclosed manner; the top wall of the reflector 1501 defines a big hole 1506 for the insertion of a LED module or lamp tube into the inside of the reflector 1501 and two small holes 1507;1508 for the fixation of the lamp bracket or the LED module. Further, the design of the stepped arched wall portions as indicated in the aforesaid second and third embodiments may be employed to this tenth embodiment.

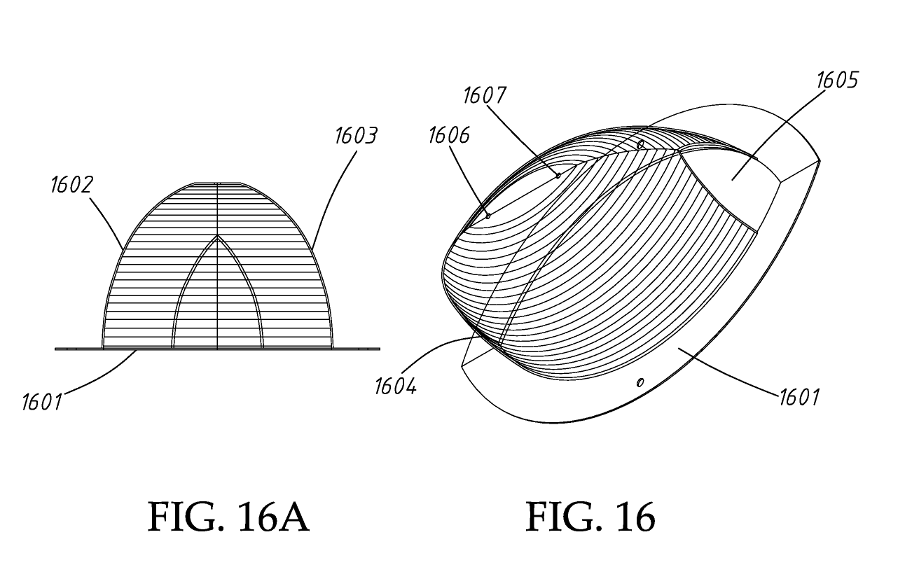

FIGS. 16 and 16A illustrate a shaped reflector 1601 in accordance with an eleventh embodiment of the present invention. According to this eleventh embodiment, the inner surface of the shaped reflector 1601 is a light reflective surface; the two opposing lateral walls 1602;1603 are convex walls each consisting of a plurality of conical faces abutted against one another at different elevations and sloping at different angles in such a manner that each conical face slopes upwardly toward the center of the reflector 1601 and one upper conical face slopes relatively closer to the center of the shaped reflector than the adjacent lower conical face and each conical face has a width gradually reducing in direction from the bottom side of the reflector 1601 toward the top side thereof; the front wall 1604 of the reflector 1601 is convex wall connected between the two opposing lateral sidewalls of the reflector 1601; the back wall 1605 of the reflector 1601 has a through hole for the insertion of the lamp tube into the inside of the reflector 1601; the top wall of the reflector 1601 has two small through holes 1607;1608 for the fixation of the lamp bracket. Further, the design of the stepped arched wall portions as indicated in the aforesaid second and third embodiments may be employed to this eleventh embodiment.

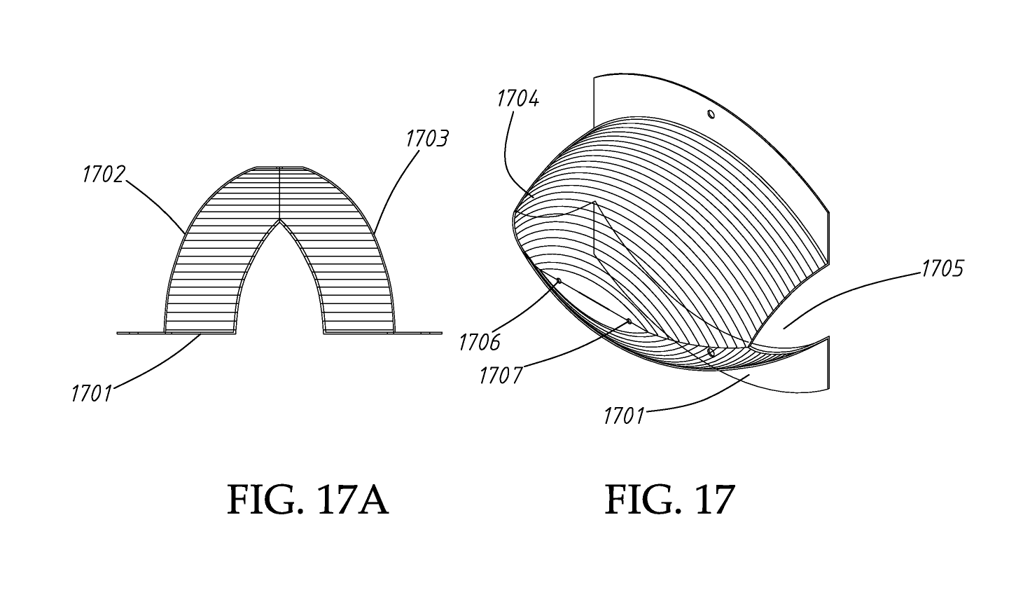

FIGS. 17 and 17A illustrate a shaped reflector 1701 in accordance with a twelfth embodiment of the present invention. According to this twelfth embodiment, the inner surface of the shaped reflector 1701 is a light reflective surface; the two opposing lateral walls 1702;1703 are convex walls each consisting of a plurality of conical faces abutted against one another at different elevations and sloping at different angles in such a manner that each conical face slopes upwardly toward the center of the reflector 1701 and one upper conical face slopes relatively closer to the center of the shaped reflector than the adjacent lower conical face and each conical face has a width gradually reducing in direction from the bottom side of the reflector 1701 toward the top side thereof; the front wall 1704 and back wall 1705 of the reflector 1701 each have a through hole for the passing of the lamp tube; the top wall of the reflector 1701 has two small through holes 1706;1707 for the fixation of the lamp bracket. Further, the design of the stepped arched wall portions as indicated in the aforesaid second and third embodiments may be employed to this eleventh embodiment.

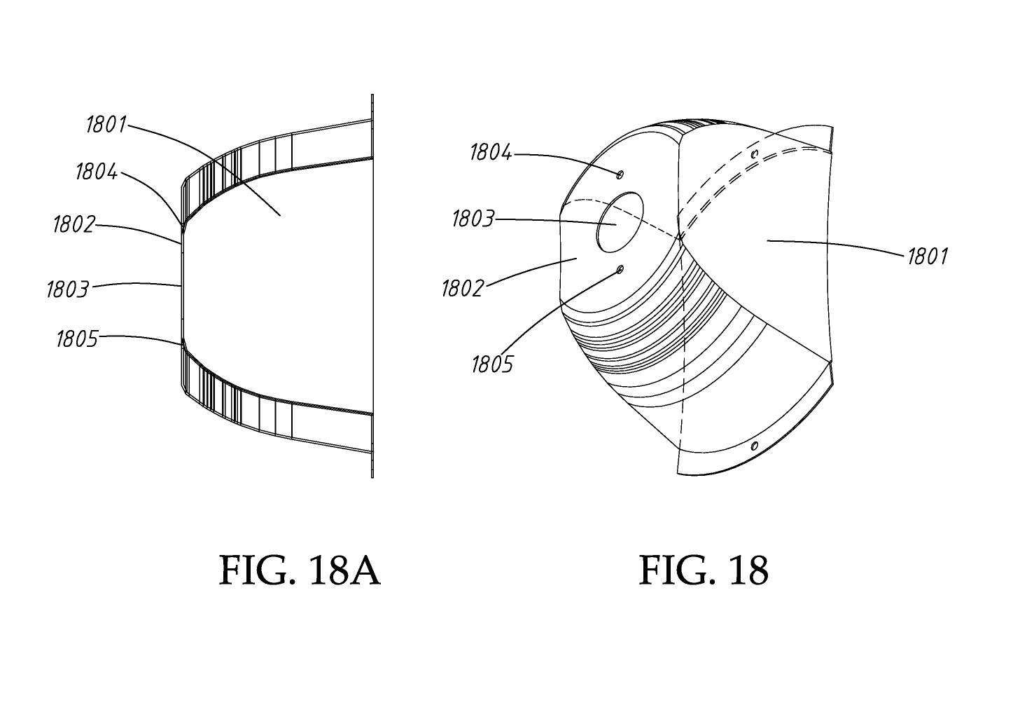

FIGS. 18 and 18A illustrate a shaped reflector 1801 in accordance with a thirteenth embodiment of the present invention. According to this thirteenth embodiment, the design of the two opposing lateral sidewalls, front wall and back wall of the shaped reflector 1801 are sane as the design shown in FIG. 2; the top wall of the reflector 1801 is a planar wall 1802 having a big through hole 1803 for the insertion of the lamp tube or LED module and two small through holes 1804;1805 for the fixation of the lamp bracket or the LED module.

Further, the aforesaid conical faces that are abutted against one another at different elevations and slope at different angles can be arranged in a concentric manner or non-concentric manner.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A lighting fixture, comprising:
a light source for producing light; and
a shaped reflector surrounding said light source, said shaped reflector comprising a top wall, a bottom open side opposite to said top wall, two opposing sidewalls, a front wall and a back wall opposite to said front wall, said top wall, said sidewalls, said front wall and said back wall being adapted for reflecting the light emitted by said light source toward said bottom open side onto a predetermined illumination area;
wherein said sidewalls of said shaped reflector curve outwards, each comprising a plurality of conical faces abutted against one another at different elevations and sloping at different angles in such a manner that one upper conical face slopes relatively closer to the center of the shaped reflector than the adjacent lower conical face, the width of each said sidewall gradually reducing in direction from the bottom open side of said shaped reflector toward the top wall thereof;
said top wall of said shaped reflector curves inwards, comprising two symmetric sets of tapered faces that are abutted against one another and respectively sloping at a different angle toward the center of said shaped reflector, the angle of slope of one said tapered face that is relatively closer to the center of said shaped reflector being greater than the angle of slope of another said tapered face that is relatively farther from the center of said shaped reflector;
said front wall and said back wall of said shaped reflector are respectively inwardly curved in reversed directions, having one same curvature and sloping downwardly outwardly in direction from said top wall of said shaped reflector toward said bottom open, said front wall and said back wall each having a width gradually reducing in direction from the bottom open side of said shaped reflector toward said top wall.

2. The lighting fixture as claimed in claim 1, further comprising:
a power supply device adapted for providing electric power to said light source;
a dustcover surrounding said shaped reflector, said dustcover comprising a bottom opening for letting light go out of said shaped reflector and two inside brackets for securing said shaped reflector; and
a prism mounted in said bottom opening of said dustcover.

3. The lighting fixture as claimed in claim 2, wherein said shaped reflector further comprises two planar bottom flanges respectively outwardly extended from a bottom side of each of the two opposing sidewalls thereof in a flush manner relative to the bottom open side thereof and a mounting through hole respectively located on each of said two planar bottom flanges for fastening to said inside brackets of said dustcover.

4. The lighting fixture as claimed in claim 1, wherein said two opposing sidewalls of said shaped reflector are asymmetric, having different widths.

5. The lighting fixture as claimed in claim 1, wherein said two opposing sidewalls of said shaped reflector are asymmetric relative to the center line of said shaped reflector, each having a relatively narrower first part and a relatively wider second part.

6. The lighting fixture as claimed in claim 1, wherein said inwardly curved front wall and back wall of said shaped reflector are asymmetric, having one same radius and sloping at a different angle.

7. The lighting fixture as claimed in claim 1, wherein said inwardly curved front wall and back wall of said shaped reflector are asymmetric, having a different radius and sloping at a different angle.

8. The lighting fixture as claimed in claim 1, wherein said inwardly curved front wall and back wall of said shaped reflector each comprise a plurality of inclined planar faces.

9. The lighting fixture as claimed in claim 1, wherein said inwardly curved front wall and back wall of said shaped reflector each comprise a plurality of inclined arched faces.

10. A lighting fixture, comprising:
a light source for producing light; and
a shaped reflector surrounding said light source, said shaped reflector comprising a top wall, a bottom open side opposite to said top wall, two opposing sidewalls, a front wall and a back wall opposite to said front wall, said top wall, said sidewalls, said front wall and said back wall each having a reflective inner surface adapted for reflecting the light emitted by said light source toward said bottom open side onto a predetermined illumination area;
wherein each said sidewall of said shaped reflector comprises a first stepped arched wall portion, a second stepped arched wall portion and a first planar face horizontally connected between said first stepped arched wall portion and said second stepped arched wall portion, said first stepped arched wall portion and said second stepped arched wall portion each comprising a plurality of conical faces abutted against one another at different elevations and respectively and upwardly inwardly sloping at different angles in such a manner that one upper conical face slopes relatively closer to the center of said shaped reflector than the adjacent lower conical face, the width of said conical faces reducing gradually in direction from the bottom open side of said shaped reflector toward the top wall thereof.
said front wall and said back wall of said shaped reflector are respectively inwardly curved in reversed directions, having one same curvature and sloping downwardly outwardly in direction from said top wall of said shaped reflector toward said bottom open, said front wall and said back wall each having a width gradually reducing in direction from the bottom open side of said shaped reflector toward said top wall.

11. The lighting fixture as claimed in claim 10, further comprising:
a power supply device adapted for providing electric power to said light source;
a dustcover surrounding said shaped reflector, said dustcover comprising a bottom opening for letting light go out of said shaped reflector and two inside brackets for securing said shaped reflector; and
a prism mounted in said bottom opening of said dustcover.

12. The lighting fixture as claimed in claim 11, wherein said shaped reflector further comprises two planar bottom flanges respectively outwardly extended from a bottom side of each of the two opposing sidewalls thereof in a flush manner relative to the bottom open side thereof and a mounting through hole respectively located on each of said two planar bottom flanges for fastening to said inside brackets of said dustcover.

13. The lighting fixture as claimed in claim 10, wherein said first stepped arched wall portion and said second stepped arched wall portion of each said sidewall of said shaped reflector have different widths.

14. The lighting fixture as claimed in claim 10, wherein said two opposing sidewalls of said shaped reflector are asymmetric relative to the center line of said shaped reflector, each having a relatively narrower first part and a relatively wider second part.

15. The lighting fixture as claimed in claim 10, wherein said inwardly curved front wall and back wall of said shaped reflector are asymmetric, having one same radius and sloping at a different angle.

16. The lighting fixture as claimed in claim 10, wherein said inwardly curved front wall and back wall of said shaped reflector are asymmetric, having a different radius and sloping at a different angle.

17. The lighting fixture as claimed in claim 10, wherein said inwardly curved front wall and back wall of said shaped reflector each comprise a plurality of inclined planar faces.

18. The lighting fixture as claimed in claim 10, wherein said inwardly curved front wall and back wall of said shaped reflector each comprise a plurality of inclined arched faces.

19. The lighting fixture as claimed in claim 10, wherein each said sidewall of said shaped reflector further comprises a third stepped arched wall portion disposed above the elevation of said second stepped arched wall portion, and a second planar face horizontally connected between said second stepped arched wall portion and said third stepped arched wall portion.

20. A lighting fixture, comprising:
a light source for producing light; and
a shaped reflector surrounding said light source, said shaped reflector comprising a top wall, a bottom open side opposite to said top wall, two opposing sidewalls, a front wall and a back wall opposite to said front wall, said top wall, said sidewalls, said front wall and said back wall each having a reflective inner surface adapted for reflecting the light emitted by said light source toward said bottom open side onto a predetermined illumination area;
wherein each said sidewall of said shaped reflector consists of a plurality of conical faces abutted against one another at different elevations and respectively and upwardly inwardly sloping at different angles in such a manner that one upper conical face slopes relatively closer to the center of said shaped reflector than the adjacent lower conical face, each said conical face having a width reducing gradually in direction from the bottom open side of said shaped reflector toward the top wall of said shaped reflector; the front wall and back wall of said reflector are connected between the two opposing lateral walls thereof in an enclosed manner; the top wall of said reflector defines a big through hole for the insertion of said light source into the inside of said reflector and two small through holes for the fixation of said light source directly or a bracket holding said light source.

21. A lighting fixture, comprising:
a light source for producing light; and
a shaped reflector surrounding said light source, said shaped reflector comprising a top wall, a bottom open side opposite to said top wall, two opposing sidewalls, a front wall and a back wall opposite to said front wall, said top wall, said sidewalls, said front wall and said back wall each having a reflective inner surface adapted for reflecting the light emitted by said light source toward said bottom open side onto a predetermined illumination area;
wherein each said sidewall of said shaped reflector consists of a plurality of conical faces abutted against one another at different elevations and respectively and upwardly inwardly sloping at different angles in such a manner that one upper conical face slopes relatively closer to the center of said shaped reflector than the adjacent lower conical face, each said conical face having a width reducing gradually in direction from the bottom open side of said shaped reflector toward the top wall of said shaped reflector; the front wall and back wall of said reflector are connected between the two opposing lateral walls thereof in an enclosed manner; the front wall of said reflector is connected between the two opposing sidewalls of said reflector in an enclosed manner; the back wall of said reflector defines a through hole for the insertion of said light source into the inside of said reflector; the top wall of said reflector defines two small through holes for the fixation of said light source directly or a bracket holding said light source.

22. A lighting fixture, comprising:
a light source for producing light; and
a shaped reflector surrounding said light source, said shaped reflector comprising a top wall, a bottom open side opposite to said top wall, two opposing sidewalls, a front wall and a back wall opposite to said front wall, said top wall, said sidewalls, said front wall and said back wall each having a reflective inner surface adapted for reflecting the light emitted by said light source toward said bottom open side onto a predetermined illumination area;
wherein each said sidewall of said shaped reflector consists of a plurality of conical faces abutted against one another at different elevations and respectively and upwardly inwardly sloping at different angles in such a manner that one upper conical face slopes relatively closer to the center of said shaped reflector than the adjacent lower conical face, each said conical face having a width reducing gradually in direction from the bottom open side of said shaped reflector toward the top wall of said shaped reflector; the front wall and back wall of said reflector each define a through hole for the insertion of said light source; the top wall of said reflector defines two small through holes for the fixation of said light source directly or a bracket holding said light source.

23. A lighting fixture, comprising:
a light source for producing light; and
a shaped reflector surrounding said light source, said shaped reflector comprising a top wall, a bottom open side opposite to said top wall, two opposing sidewalls, a front wall and a back wall opposite to said front wall, said top wall, said sidewalls, said front wall and said back wall each having a reflective inner surface adapted for reflecting the light emitted by said light source toward said bottom open side onto a predetermined illumination area;
wherein each said sidewall of said shaped reflector consists of a plurality of conical faces abutted against one another at different elevations and respectively and upwardly inwardly sloping at different angles in such a manner that one upper conical face slopes relatively closer to the center of said shaped reflector than the adjacent lower conical face, each said conical face having a width reducing gradually in direction from the bottom open side of said shaped reflector toward the top wall of said shaped reflector; the top wall of said reflector is a planar wall; the front wall and back wall of said reflector are concave walls respectively curved downwardly outwardly away from the center of said reflector and having a width reducing gradually in direction from the bottom open side of said shaped reflector toward the top wall of said shaped reflector.
